(19) United States
(12) Patent Application Publication
(10) Pub. No.: US 2016/0246163 A1
(43) Pub. Date: Aug. 25, 2016

(54) Automatically Rotating Camera Flash Bracket

(71) Applicant: Jose Fernandez, Midvale, UT (US)

(72) Inventor: Jose Fernandez, Midvale, UT (US)

(21) Appl. No.: 14/994,849

(22) Filed: Jan. 13, 2016

Related U.S. Application Data
(60) Provisional application No. 62/102,613, filed on Jan. 13, 2015.

(51) Int. Cl. G03B 17/56; G03B 15/02

(52) U.S. Cl. CPC G03B 17/566; G03B 15/02

(57) ABSTRACT

An automatically rotating camera flash bracket. The present bracket comprises two arms, one L-shaped and one straight. The bracket connects to a camera on one end and a flash on the other end. The two arms are joined together with a hinge that is connected to a motor. The motor is controlled by a microprocessor that adjusts the angle between the two arms depending on the orientation of the camera, which is determined by an orientation sensor. Both the motor and the microprocessor are powered by a power source.

### CROSS REFERENCE TO RELATED APPLICATIONS

This application claims the benefit of U.S. Provisional Application No. 62/102,613 filed on Jan. 13, 2015. The above identified patent application is herein incorporated by reference in its entirety to provide continuity of disclosure.

### BACKGROUND OF THE INVENTION

The present invention relates to camera flash brackets. More specifically, the present invention relates to camera flash brackets that rotate automatically depending on the orientation that the bracket is held at by a user.

Photography has long used the help of flash units to compensate for low ambient lighting. While many modern cameras include a small built-in flash unit, there are numerous advantages to using an external flash. External flash units offer many times more power than a built-in unit, resulting not only in more useable light, but faster recharge times between flashes. Additionally, because external flash units do not rely on the camera battery, they can extend the length of time a camera can be used on each battery charge. Another advantage in using an external flash unit is the reduction of unwanted results when using a flash that is positioned particularly close to a camera lens. A source of light that is relatively close to the lens can result in particularly harsh lighting, as well as a significant increase in the likelihood of creating a “red eye” effect from light bouncing off the inner eye. Using a source of light that is placed farther away from the lens significantly decreases these unwanted effects.

These external units do not come without some obstacles. A significant drawback to using an external flash unit is when the camera is rotated to take a picture in a portrait (vertical) orientation. Because the flash connection point, known as a hot shoe, is conventionally placed on top of the camera when it is held in the landscape (horizontal) position, a flash connected in the portrait orientation will illuminate the subject from the side, casting uneven and often undesired shadows.

In order to address this issue, there exists in the prior art brackets that are designed to position a flash at multiple angles, allowing the flash head to consistently be placed directly above the lens in both the portrait and landscape orientations. While this provides a viable solution, it can be tiresome and time consuming to rotate the bracket for a photographer who switches camera orientation often.

### SUMMARY OF THE INVENTION

In view of the foregoing disadvantages inherent in the known types of camera flash brackets now present in the prior art, the present invention provides a camera flash bracket wherein the same can be utilized for providing convenience for the user by automatically adjusting the position of the flash based on the orientation of the camera. The present bracket comprises two arms, one L-shaped and one straight. The bracket connects to a camera on one end and a flash on the other end. The two arms are joined together with a hinge that is connected to a motor. The motor is controlled by a microprocessor that adjusts the angle between the two arms depending on the orientation of the camera, which is determined by an orientation sensor. Both the motor and the microprocessor are powered by a power source.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an embodiment of the automatically rotating camera flash bracket.

FIG. 1B shows a perspective view of an embodiment of the automatically rotating camera flash bracket wherein the second arm is rotated relative to the first arm.

FIG. 2 shows an exploded view of an embodiment of the automatically rotating camera flash bracket.

FIG. 3 shows an exploded view of an alternative embodiment of the automatically rotating camera flash bracket.

FIG. 4 shows a schematic diagram of part of the automatically rotating camera flash bracket.

### DETAILED DESCRIPTION OF THE INVENTION

Reference is made herein to the attached drawings. Like reference numerals are used throughout the drawings to depict like or similar elements of the automatically rotating camera flash bracket. The figures are intended for representative purposes only and should not be considered to be limiting in any respect. As used herein, “microprocessor” refers to (i) logic implemented as computer instructions and/or data within one or more computer processes and/or (ii) logic implemented in electronic circuitry.

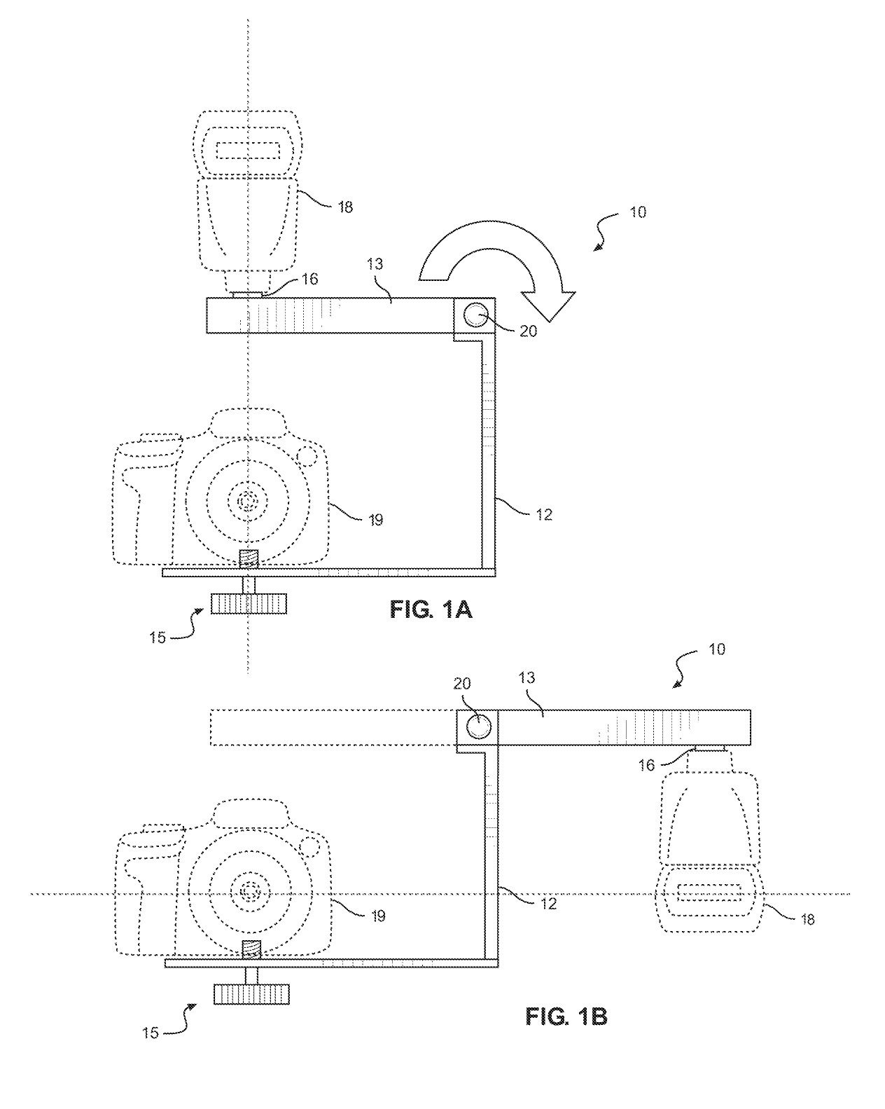

Referring now to FIGS. 1A and 1B, there are shown perspective views of an embodiment of the automatically rotating camera flash bracket. The automatically rotating flash bracket 10 comprises a first arm 12 that is L-shaped and a second arm 13 that is straight. The two arms are pivotally connected by a hinge 20. The first arm 12 is configured to securely connect to a camera 19 and the second arm 13 is configured to securely connect to a flash unit 18. For example, in one embodiment of the bracket 10 there is a threaded shank on one end of the first arm 12 that is configured to engage a complementary threaded recess on a camera 15 and a recess on one end of the second arm 13 configured to engage a mount of a flash unit 16.

The second arm 13 is configured to pivot around the hinge 20 in a 180 degree arc, allowing the bracket to assume a C-like shape in a first position and a Z-like shape in a second position. The first arm 12 and second arm 13 are configured with dimensions that allow the center of the camera lens to be substantially aligned with the center of the flash unit in both the horizontal and the vertical position, such that the light emitted from the flash unit is centered above the lens.

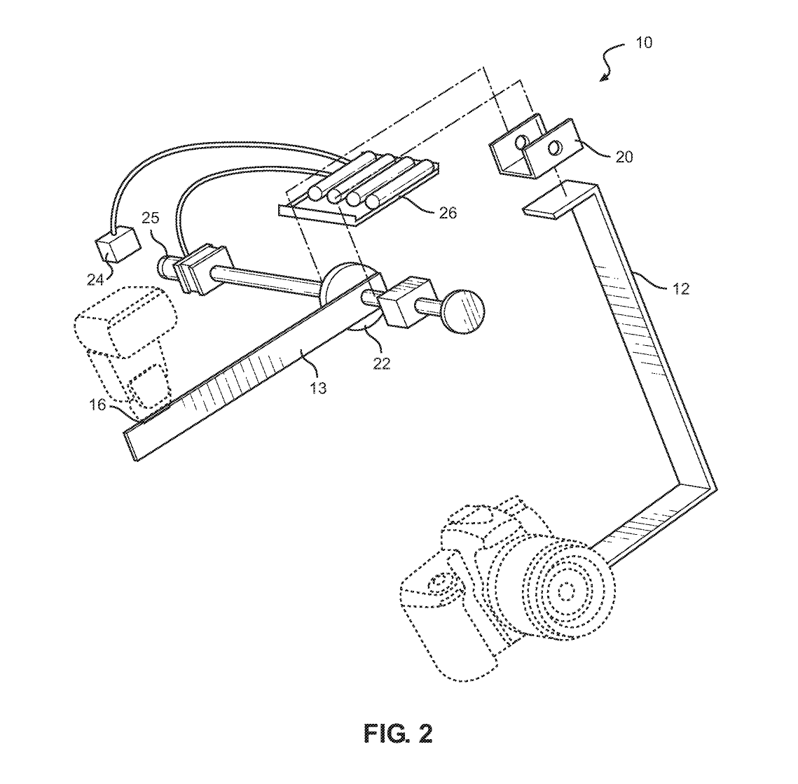

Referring now to FIG. 2 an exploded view of an embodiment of the automatically rotating camera flash bracket is shown. The hinge 20 is disposed on the first arm 12 and pivotally connected to the second arm 13. The hinge 20 is controlled by a motor 25 that is operably connected to a power supply 26 and a microprocessor 24. In one embodiment of the invention, the power supply 26 can be a rechargeable lithium ion battery. In another embodiment of the invention, the power supply 26 can be a battery pack that accepts standard alkaline or nickel-metal hydride battery that can be mounted on the side of the bracket 10.

The microprocessor 24 is operably connected to an orientation sensor 22. In one embodiment of the invention, the orientation sensor 22 is a gyroscope. In another embodiment of the invention, the orientation sensor 22 is an accelerometer. So long as a horizontal orientation is detected by the orientation sensor 22, the arms extend in the same direction. When the orientation sensor 22 detects that the camera and bracket 10 have been rotated to a vertical orientation, a signal is relayed from the orientation sensor 22 to the microprocessor 24, which in turn signals the motor 25 to rotate the second arm 13 180 degrees.

In one embodiment of the bracket 10, the motor 25 is operably connected to the second arm 13, such that when activated, the motor applies a torque to the second arm 13, which then pivots around the hinge 20. In another embodiment of the invention, the motor 25 is operably connected to hinge 20, the hinge 20 being securely and non-pivotally connected to the second arm 13. The motor applies torque to the hinge 20, rotating both the hinge 20 and the second arm 13 180 degrees.

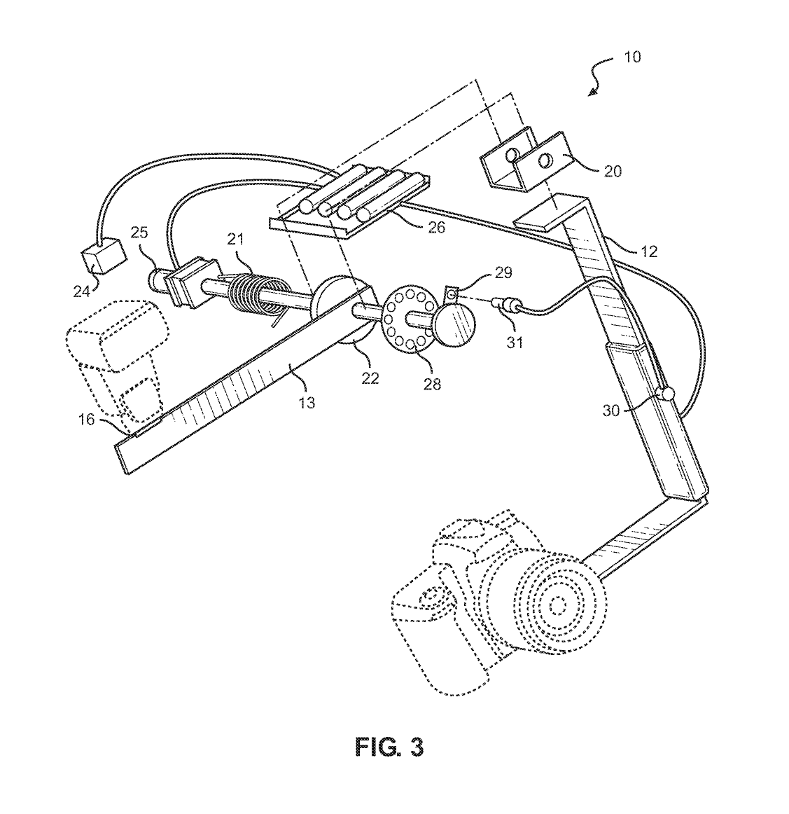

Referring now to FIG. 3, there is shown an exploded view of an alternative embodiment of the automatically rotating camera flash bracket. There is a manual switch 30 disposed on the first arm 12. The manual switch 30 is configured to control a locking mechanism, allowing a user to override the orientation sensor 22 and motor 25 and rotate the second arm 13 manually. In one embodiment of the invention, the locking mechanism comprises a locking ring 28 and a locking pin 31. The locking ring 28 is disposed on the hinge 20 and comprises a ring with a number of apertures surrounding the external edge. The manual switch 30 is connected the locking pin 31, such that when the manual switch 30 is not depressed, the locking pin 31 prevents the locking ring 28 from rotating. The locking pin 31 is held in place with a secure slot 29. When the manual switch is depressed, the locking pin 31 retracts, allowing the locking ring 28 and the second arm 13, along with the flash unit, to rotate. In an additional embodiment of the automatically rotating flash bracket 10, there is a torsion spring 21 disposed on the hinge 20. The torsion spring 21 is configured to apply a rotational force to the second arm to counterbalance the weight of a flash unit, allowing the motor 25 to more easily rotate the second arm 13.

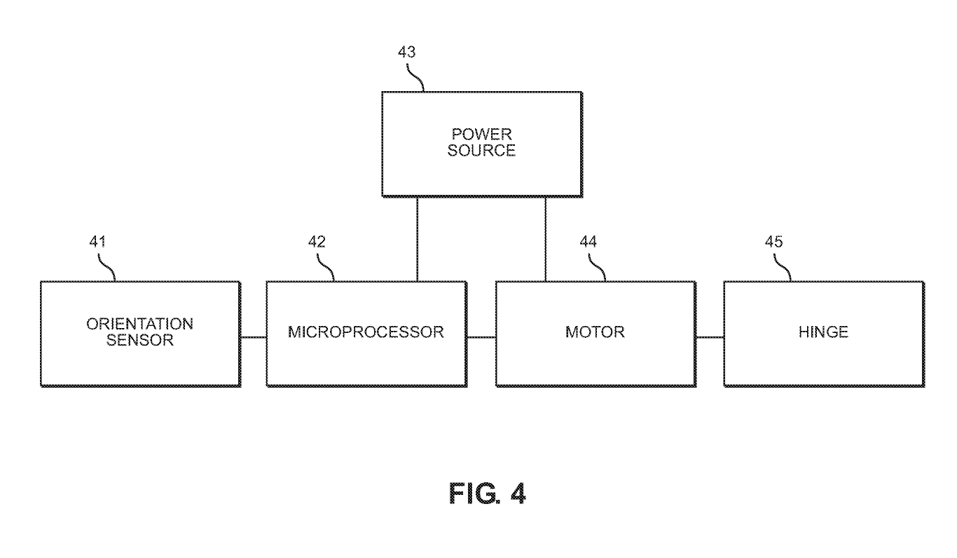

FIG. 4 shows a schematic diagram of an embodiment of the automatically rotating camera flash bracket. The microprocessor 42 and motor 44 and operably connected to the power source 43. The microprocessor 42 is operably connected to the orientation sensor 41. When a shift of orientation is detected, a signal is relayed from the orientation sensor 41 to the microprocessor 42, which sends a signal to activate the motor 44 to rotate the hinge 45. Alternatively, the motor can be configured to rotate the second arm.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An automatically rotating camera flash bracket, comprising:
a first arm, the first arm having a first end and a second end, the first end connectable to a camera;
a second arm, the second arm having a first end and a second end, the first end connectable to a flash unit;
a hinge pivotally connecting the first arm and the second arm;
a motor configured to rotate the second arm 180 degrees;
an orientation sensor;
a microprocessor operably connected to the motor and the orientation sensor, the microprocessor configured to activate the motor based on the orientation of the flash bracket.

2) The automatically rotating camera flash bracket of claim 1, wherein the first end of the first arm comprises a threaded shank that is configured to engage a complementary threaded recess on a camera body.

3) The automatically rotating camera flash bracket of claim 1, wherein the first end of the second arm comprises a receptacle.

4) The automatically rotating camera flash bracket of claim 1, further comprising a torsion spring disposed on the hinge, configured to apply a rotational force to the second arm.

5) The automatically rotating camera flash bracket of claim 1, wherein the orientation sensor is a gyroscope.

6) The automatically rotating camera flash bracket of claim 1, wherein the orientation sensor is an accelerometer.

7) The automatically rotating camera flash bracket of claim 1, further comprising:
a lock ring disposed on the hinge, the lock ring comprising a disc with apertures placed around the outer edge;
a locking pin, disposed adjacent to the lock ring and configured to engage with the apertures to prevent the lock ring from rotating.

8) The automatically rotating camera flash bracket of claim 7, further comprising a manual switch configured to control the locking pin.
